(19) United States
(12) Patent Application Publication
(10) Pub. No.: US 2021/0224937 A1
(43) Pub. Date: Jul. 22, 2021

(54) SYSTEM AND METHOD FOR AUTOMATED ATTORNEY REFERRAL AND LEGAL DOCUMENT PREPARATION

(71) Applicant: KEELEG TECH, INC., San Francisco, CA (US)

(72) Inventors: Anthony Luna, Walnut Creek, CA (US); Padam Thakur, San Ramon, CA (US); Zaceria Mohideen, Fremont, CA (US)

(21) Appl. No.: 17/151,639

(22) Filed: Jan. 18, 2021

Related U.S. Application Data
(60) Provisional application No. 62/962,102, filed on Jan. 16, 2020.

(51) Int. Cl. G06Q 50/18; G06F 40/174; G06F 40/35; G06F 40/58

(52) U.S. Cl. CPC G06Q 50/18; G06F 40/174; H04L 51/02; G06F 40/58; G06F 40/35

(57) ABSTRACT

Described is a system for automated attorney referral and legal document preparation. The system provides a user interface with a list of options for legal needs. The interface also includes an ask option, in which the user can engage with a chat bot. If the user provides natural language into the ask option, the natural language is processed to identify user intent and generate a corresponding response. Alternatively, if the user selects an option from the list of preset options, the user is then provided with qualifying questions to determine if the user is qualified to proceed with the selected option. If qualified, the system then requests and stores information related to the selected option, as well as generating a relevant form and storing the form for download by the user. If the user is not qualified, then the user is referred to a attorney for further consultation.

### CROSS-REFERENCE TO RELATED APPLICATIONS

This is a non-provisional application of U.S. Provisional Application No. 62/962,102, filed on Jan. 16, 2020, the entirety of which is incorporated herein by reference.

### BACKGROUND OF INVENTION

### (1) Field of Invention

The present invention relates to a referral and document preparation system and, more specifically, to an automated attorney referral and legal document preparation system.

### (2) Description of Related Art

Document preparation companies offer a variety of services in which a user can select, download and fill out their own legal documents. While somewhat operable, existing systems are not efficient nor automated. Further, existing referral companies typically require staff to field all calls before making referrals. As can be appreciated, the use of staff to answer and field calls is extraordinarily labor intensive and, even then, is prone to human error.

Thus, a continuing need exists for an automated attorney referral and legal document preparation system.

### SUMMARY OF INVENTION

The present disclosure provides a system for automated attorney referral and legal document preparation. In some aspects, the system includes one or more processors and associated memory. The memory is a non-transitory computer-readable medium having executable instructions encoded thereon, such that upon execution of the instructions, the one or more processors collectively perform several operations, such as:
providing a user with a user interface, the user interface providing a list of preset options and an ask option;
receiving a selection from the user, such that:
   if the user provides natural language into the ask option, processing the natural language to identify the user intent and generating a corresponding response, or
   if the user selects an option from the list of preset options, then providing the user qualifying questions to determine if the user is qualified to proceed with the selected option;
      if the user is qualified to proceed with the selected option, then requesting and storing information related to the selected option in a database, then generating a form related to the selected option and storing the form for download by the user; or
      if the user is not qualified to proceed with the selected option, then referring the user to one or more attorneys.

In another aspect, the user interface is provided to the user in a mobile application as downloaded onto the user's mobile device.

In yet another aspect, the user interface includes a chatbot that automatically processes the user response.

In yet another aspect, processing the natural language to identify the user intent and generating a corresponding response utilizes natural language processing.

In another aspect, optical character recognition is used to obtain user information for filling the form.

Finally, the present invention also includes a computer program product and a computer implemented method. The computer program product includes computer-readable instructions stored on a non-transitory computer-readable medium that are executable by a computer having one or more processors, such that upon execution of the instructions, the one or more processors perform the operations listed herein. Alternatively, the computer implemented method includes an act of causing a computer to execute such instructions and perform the resulting operations.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is a block diagram depicting the components of a system according to various embodiments of the present invention;

FIG. 2 is an illustration of a computer program product embodying an aspect of the present invention;

FIG. 3 is an illustration depicting architecture of the system according to various embodiments of the present invention;

FIG. 4 is a flowchart depicting form filling and natural language processing according to various embodiments of the present invention;

FIG. 5 is a flowchart depicting an optical character recognition (OCR) process according to various embodiments of the present invention; and

FIG. 6 is a sequence diagram according to various embodiments of the present invention.

### DETAILED DESCRIPTION

The present invention relates to a referral and document preparation system and, more specifically, to an automated attorney referral and legal document preparation system. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of aspects. Thus, the present invention is not intended to be limited to the aspects presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Before describing the invention in detail, first a description of the various principal aspects of the present invention is provided. Subsequently, specific details of various embodiment of the present invention are provided to give an understanding of the specific aspects.

### (1) Principal Aspects

Various embodiments of the invention include three “principal” aspects. The first is a system for automated attorney referrals and legal document preparation. The system is typically in the form of a computer system operating software. One skilled in the art can appreciate that the system also includes the relevant hardware for machine learning to provide the appropriate actions between the systems and the user. This system may be incorporated into a wide variety of devices that provide different functionalities. The second principal aspect is a method, typically in the form of software, operated using a data processing system (computer). The third principal aspect is a computer program product. The computer program product generally represents computer-readable instructions stored on a non-transitory computer-readable medium such as an optical storage device, e.g., a compact disc (CD) or digital versatile disc (DVD), or a magnetic storage device such as a floppy disk or magnetic tape. Other, non-limiting examples of computer-readable media include hard disks, read-only memory (ROM), and flash-type memories. It should also be noted that the computer program product in some aspects is provided as a SaaS (software as a service), available only via a web application, downloadable mobile device application, and/or web API BaaS (backend as a service). These aspects will be described in more detail below.

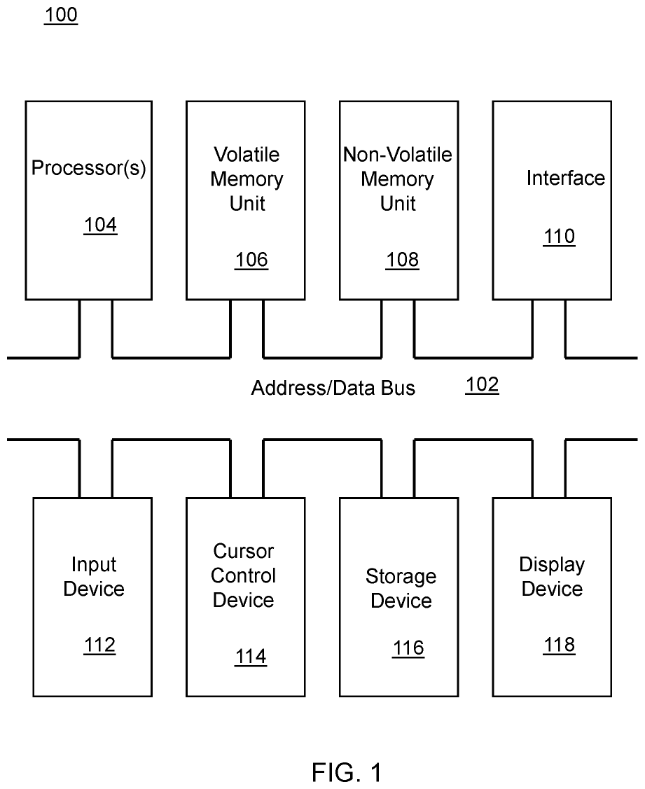

A block diagram depicting an example of a system (i.e., computer system 100) of the present invention is provided in FIG. 1. The computer system 100 is configured to perform calculations, processes, operations, and/or functions associated with a program or algorithm. In one aspect, certain processes and steps discussed herein are realized as a series of instructions (e.g., software program) that reside within computer readable memory units and are executed by one or more processors of the computer system 100. When executed, the instructions cause the computer system 100 to perform specific actions and exhibit specific behavior, such as described herein.

The computer system 100 may include an address/data bus 102 that is configured to communicate information. Additionally, one or more data processing units, such as a processor 104 (or processors), are coupled with the address/data bus 102. The processor 104 is configured to process information and instructions. In an aspect, the processor 104 is a microprocessor. Alternatively, the processor 104 may be a different type of processor such as a parallel processor, application-specific integrated circuit (ASIC), programmable logic array (PLA), complex programmable logic device (CPLD), or a field programmable gate array (FPGA).

The computer system 100 is configured to utilize one or more data storage units. The computer system 100 may include a volatile memory unit 106 (e.g., random access memory (“RAM”), static RAM, dynamic RAM, etc.) coupled with the address/data bus 102, wherein a volatile memory unit 106 is configured to store information and instructions for the processor 104. The computer system 100 further may include a non-volatile memory unit 108 (e.g., read-only memory (“ROM”), programmable ROM (“PROM”), erasable programmable ROM (“EPROM”), electrically erasable programmable ROM “EEPROM”), flash memory, etc.) coupled with the address/data bus 102, wherein the non-volatile memory unit 108 is configured to store static information and instructions for the processor 104. Alternatively, the computer system 100 may execute instructions retrieved from an online data storage unit such as in “Cloud” computing. In an aspect, the computer system 100 also may include one or more interfaces, such as an interface 110, coupled with the address/data bus 102. The one or more interfaces are configured to enable the computer system 100 to interface with other electronic devices and computer systems. The communication interfaces implemented by the one or more interfaces may include wireline (e.g., serial cables, modems, network adaptors, etc.) and/or wireless (e.g., wireless modems, wireless network adaptors, etc.) communication technology.

In one aspect, the computer system 100 may include an input device 112 coupled with the address/data bus 102, wherein the input device 112 is configured to communicate information and command selections to the processor 104. In accordance with one aspect, the input device 112 is an alphanumeric input device, such as a keyboard, that may include alphanumeric and/or function keys. Alternatively, the input device 112 may be an input device other than an alphanumeric input device. In an aspect, the computer system 100 may include a cursor control device 114 coupled with the address/data bus 102, wherein the cursor control device 114 is configured to communicate user input information and/or command selections to the processor 104. In an aspect, the cursor control device 114 is implemented using a device such as a mouse, a track-ball, a track-pad, an optical tracking device, or a touch screen. The foregoing notwithstanding, in an aspect, the cursor control device 114 is directed and/or activated via input from the input device 112, such as in response to the use of special keys and key sequence commands associated with the input device 112. In an alternative aspect, the cursor control device 114 is configured to be directed or guided by voice commands.

In an aspect, the computer system 100 further may include one or more optional computer usable data storage devices, such as a storage device 116, coupled with the address/data bus 102. The storage device 116 is configured to store information and/or computer executable instructions. In one aspect, the storage device 116 is a storage device such as a magnetic or optical disk drive (e.g., hard disk drive (“HDD”), floppy diskette, compact disk read only memory (“CD-ROM”), digital versatile disk (“DVD”)). Pursuant to one aspect, a display device 118 is coupled with the address/data bus 102, wherein the display device 118 is configured to display video and/or graphics. In an aspect, the display device 118 may include a cathode ray tube (“CRT”), liquid crystal display (“LCD”), field emission display (“FED”), plasma display, or any other display device suitable for displaying video and/or graphic images and alphanumeric characters recognizable to a user.

The computer system 100 presented herein is an example computing environment in accordance with an aspect. However, the non-limiting example of the computer system 100 is not strictly limited to being a computer system. For example, an aspect provides that the computer system 100 represents a type of data processing analysis that may be used in accordance with various aspects described herein. Moreover, other computing systems may also be implemented. Indeed, the spirit and scope of the present technology is not limited to any single data processing environment. Thus, in an aspect, one or more operations of various aspects of the present technology are controlled or implemented using computer-executable instructions, such as program modules, being executed by a computer. In one implementation, such program modules include routines, programs, objects, components and/or data structures that are configured to perform particular tasks or implement particular abstract data types. In addition, an aspect provides that one or more aspects of the present technology are implemented by utilizing one or more distributed computing environments, such as where tasks are performed by remote processing devices that are linked through a communications network, or such as where various program modules are located in both local and remote computer-storage media including memory-storage devices.

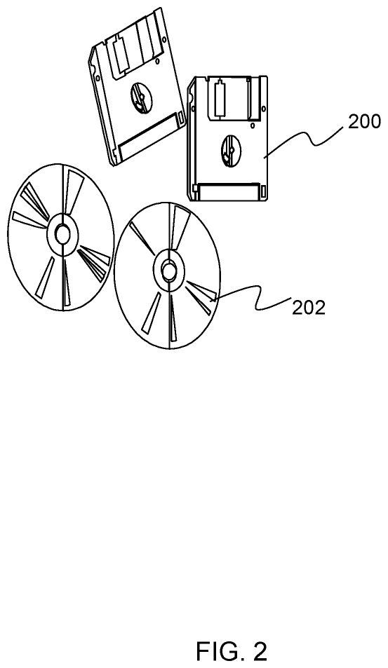

An illustrative diagram of a computer program product (i.e., storage device) embodying the present invention is depicted in FIG. 2. The computer program product is depicted as floppy disk 200 or an optical disk 202 such as a CD or DVD. However, as mentioned previously, the computer program product generally represents computer-readable instructions stored on any compatible non-transitory computer-readable medium and can be offered, in some aspects, as a SaaS or otherwise downloadable software/service. The term “instructions” as used with respect to this invention generally indicates a set of operations to be performed on a computer, and may represent pieces of a whole program or individual, separable, software modules. Non-limiting examples of “instruction” include computer program code (source or object code) and “hard-coded” electronics (i.e. computer operations coded into a computer chip). The “instruction” is stored on any non-transitory computer-readable medium, such as in the memory of a computer or on a floppy disk, a CD-ROM, and a flash drive. In either event, the instructions are encoded on a non-transitory computer-readable medium.

### (2) Specific Details of Various Embodiments

The present invention is directed to a system, computer program product, and method that operate as a web application that presents a chat interface that allows the application to interact with an end user in a conversational manner. Harnessing the power of Machine Learning (ML), specifically but not limited to Natural Language Processing (NLP), the application is able to prompt the user, and to detect and analyze those responses to determine the next appropriate action. The data collected from the application will be in the form of self-described description of their legal issue/circumstance/need and follow up questions suited for their situation. The system helps the user to fill legal forms, like Immigration or Bankruptcy, by collecting the Form related information using the Chat interface. The application will attempt to assist the user in self-help of supported legal tasks, or encourage the end user to consult with a real life attorney if the complexity of the situation exceeds the capacity of the application. (i.e., assist the end user with locating the appropriate legal form(s) to use and help prepare and pre-populate the legal form(s) using end user inputs received during the course of the conversation along with providing final written instructions by email, or other media, to the end user at the end of the conversation. If at any point the data collected determines the course of action is to consult an attorney, the application will start the referral process).

Treating any deliverable or product as a result of a decision process, the system uses NLP and ML to surface data from an end user and deliver a customized product with a natural but efficient conversational chatbot. By constant evaluation on known user data and question and answers collected, the system will determine which action to take next. These actions can be one of, but not limited to, delivering the completed forms and all related media, referral to an attorney, or prompt for more information based on questions stored in a private or public datastore with relation to the data already collected. At any point if the data collected is sufficient and the application determines, with a high confidence rate (e.g., the user uses particular predefined keywords or selects a provided option), on a proper overall course of action, and is within the capacity of offerings by the application, the conversation will finish and the product will be delivered to the client via the desired media, such as display on the screen, emailed document attachment (e.g., PDF), etc.

Along with the customer web interface, the system includes an administration interface that can be presented to an administrator. The administration interface can be on a serve or, in other aspects, accessible via a web portal or interface. The administration interface serves as the portal for users with the proper privileges to add, edit, delete, and publish, supported forms and all related questions pertaining to the forms. The relationships between legal fields, forms, form fields, questions, and sample answers will also be editable via the administration interface.

Using Machine Learning algorithms, and collected sample session data, the system takes all available data collected in the same session from a user and make predictions on what course of action is the most appropriate with every interaction with the user. As more sessions occur and more session data and user feedback is collected, the confidence rate of predicted actions will be improved and tested against to increase accuracy and provide analytics as to the validity of such predictions, thereby increasing the accuracy of the provided documents, etc. Thus, it should be understood that the system as described herein utilizes the chatbot/artificial intelligence software and/or processes as a legal issue diagnostic tool. In this aspect and as described throughout this disclosure, the system receives various inputs from the user (e.g., document scan, input into the chatbot field, etc.) and checks the inputs against the brain files (and/or database) to identify the appropriate legal remedy. There are a variety of diagnostic techniques that can be implemented to provide for legal issue diagnosis. As a non-limiting example, a user may enter into the chatbot a brief phrase describing a problem they are having. The system could then pose specific legal issues (list of options) that may be appropriate and/or ask various questions to narrow down the likely legal issue. As a non-limiting example, the user may enter “I have a cool idea”. The system then searches against the brain files and/or database for various types of legal issues that may pertain to a “cool idea”, and then presents those issues to the user or asks the user for further information. In this example, the system may pose the following questions to the user, “(a) Is your cool idea an invention, (b) is your cool idea something artistic, (c) other.” If the user were to select (b), the system could then present further questions to assist the user in narrowing down the legal issues as presented, such as “(1) is your artistic idea a song, (2), is your artistic idea a story, (3) other.” If the user were to select (1), the system may then provide the following question, “Do you need assistance in filing a copyright for your song?” If they were to select yes, the system would then proceed to gather the relevant information and assist the user in preparing the forms for filing a copyright for a song. As can be appreciated by those skilled in the art, the process for diagnosis can be used for any legal issue.

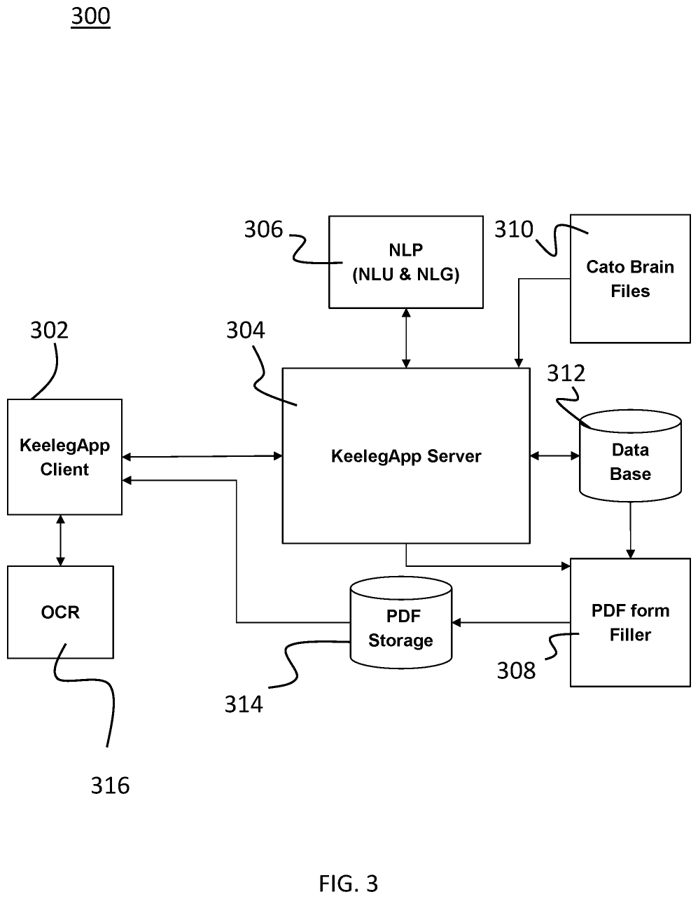

For further understanding, FIG. 3 provides a flow diagram depicting the high-level architecture 300 of the system of the present application. The chatbot interface or customer web application (accessible via the App Client 302) is based upon the client-server architecture, as depicted in FIG. 3. Specifically, the architecture 300 includes an App Client 302 which runs in a web browser or as a desktop or mobile device web application in the end user's machine. The App Client 302 uses a web application programming interface (API) for communication with the Server 304. The App Client 302 runs the client-side of the chat system. The App Client 302 also can be used to provide and/or maintain the user account creation and attorney search functionality used to refer an attorney.

The Server 304 operates as an application server that implements the server-side of the application and system. It implements the representational state transfer (REST) APIs for communication with the client. The server 304 uses NLP 306 (natural language understanding (NLU) and natural language generation (NLG)) for processing the user inputs (at the App Client 302) to find the user intent and generate a user-friendly response to the user. Once the user completes the information required to generate the form, the Form is generated by the Form (e.g., PDF) filler module 308.

A Cato Brain File module 310 is included. The Cato Brain File module 310 includes files that contain the flows and training data for the form filling (by the form filler module 308) and answering the user queries. Examples of such training data include mapping the response from the user to the field in the form.

A database 312 is included that interfaces with the server 304. The database 312 is used by the server 304 to store the user responses in any suitable format, a non-limiting example of which includes the JavaScript Object Notation (JSON) format. After the completion of the user chat, any data obtained through the user chat is used by the form filler module 308 to fill the relevant form (e.g., PDF form). Thus, the form filler module 308 is invoked by the server 304 to fill the relevant form.

Once filled, the filled form is maintained by a form storage server 314. The form storage server 314 is a secured server or database used by the form filler module 308 to store the completed forms that are to be downloaded by the user.

An optical character recognition (OCR) module 316 is include that is used by the App Client 302 to extract the relevant information from any documents uploaded by the user via the App Client 302. In other words, the App Client 302 is configured to allow an end user to scan and upload documents into the system. For example, the App Client 302 can be loaded onto a user's mobile device (which includes a camera), allowing the user to use the mobile device (and App Client 302) to easily scan and upload a document as related to their personal information or legal needs. The OCR module 316 converts the images of typed, handwritten or printed text into machine-encoded text which contains the scanned information with the machine-encoded text. The scanned information is then presented to the user for correction. Once the user corrects and confirms the information, it is saved to the database 312 for further processing.

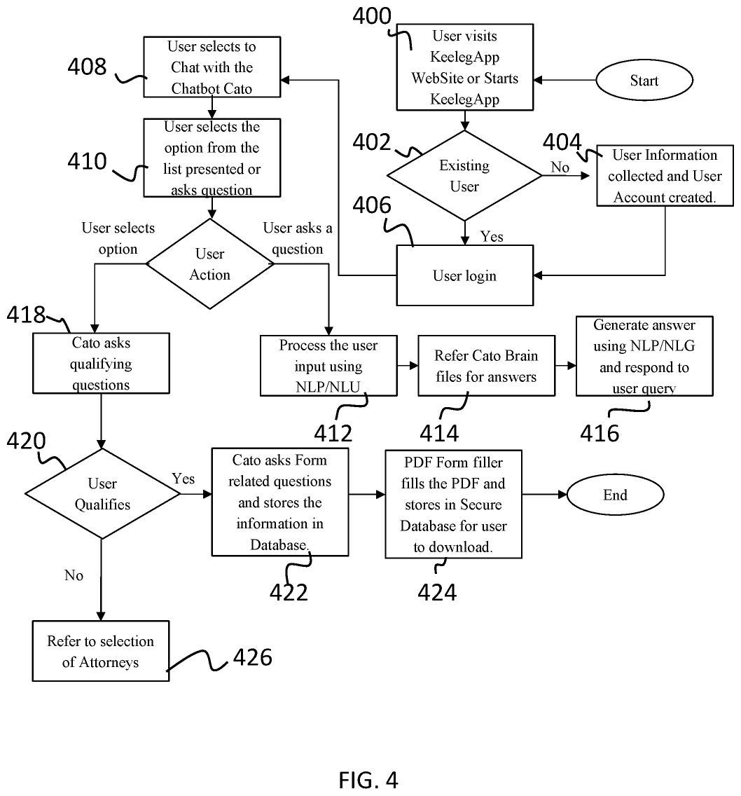

The system process and natural language processing flow is further depicted in FIG. 4. To start and initiate 400 the system, a user visits the system website or opens the software application (e.g., as loaded onto the user's mobile device or computing system). Upon launching the program, the system determines 402 if the user is an existing user or a new user (via URL address recognition or inquiry, etc. (e.g., “Returning or New User”, or simply providing a login 406 or “New User?” inquiry)). If a new user 404, user information is collected and a new user account is created. Alternatively, if an existing user, the user is allowed to login 406.

After login 406, the user can select 408 to chat (or otherwise engage) with the chatbot that will help the user determine their legal needs. The chatbot provides the user with a preset list of options, allowing the user to select 410 from the list of preset options or select to ask a question. The preset list of options are any legal needs as may be programmed into the system. For example, the present list of options may be “File for a divorce,” “Fill out Immigration Papers”, “Fill out lawsuit complaint”, etc.

IF the user asks a question (via an inquiry box or audio input, etc.), the inquiry is processed 412 using NLP/NLU, or any other suitable processing technique. The NLP/NLU attempts to take the inquiry and parse the inquiry to identify the relevant legal area as applicable to the user's query. For example, if the user writes, “Need help with my visa”, the NLP/NLU system determines that “help” and “visa” are likely applicable to immigration needs, which is then referred 414 to the Cato Brain File module to identify the relevant response or forms as may be applicable to the inquiry. The forms and files are then generated 416 and provided to the user to respond to the inquiry. For example, the user gets a response in the text as chat.

Alternatively, if the user selects one of the preset options, then the system asks 418 qualifying questions. Qualifying questions are questions which determine if the user is qualified to file the selected option. In essence, the qualifying questions are a group of screening questions. The qualifying questions determine the user's specific fact pattern in order to determine the specific legal pathway that is necessary to determine which legal form is appropriate for their circumstance, which fact-gathering question to ask next, the data to populate the appropriate legal form based on the individual's specific fact pattern and/or to decide if the user's fact situation is one of high complexity such that a knowledgeable, experienced, and expertise of a legal practitioner is needed. Examples of such qualifying questions include, but are not limited to:
1. What do you need help with?
2. Do you owe any student loans?
3. Are you a United States Citizen?
4. Are you a Legal Permanent Resident?
5. Did you travel outside of the US at all during the past 5 years?
6. Have you ever claimed to be a U.S. citizen (in writing or any other way)?
7. Have you ever been discharged from training or service in the U.S. armed forces because you were an alien?
8. When adding up all of your assets minus your liabilities, is your estate worth one (1) million dollars or more?
9. Do you own real estate?
10. Etc.

The user then answers 420 qualifying questions. Based on the answer, the system determines if the user is qualified for the particular requested service or legal need based on predetermined acceptable responses. For example, if the user starts by selecting, in step 410, that he/she would like to file for bankruptcy, then the system will ask present qualifying questions 418 to determine the user's eligibility for bankruptcy (examples of which are provided above) and what forms are applicable to the user.

Once qualified, the system proceeds 422 to inquire and obtain form related information as related to the particular case (e.g., name, address, assets, debts, etc.), then stores the information in the database. The form filler (e.g., element 308) then fills the relevant form with the obtained information and stores the filled form in the form storage server for download by the user.

If the user is unable to identify or otherwise select one of the preset options, the user is then referred 426 to a selection of attorneys for a consultation and/or services. Separately, in some aspects, the user information can be provided (via email, text, etc.) to one or more of the selection of attorneys as a potential client.

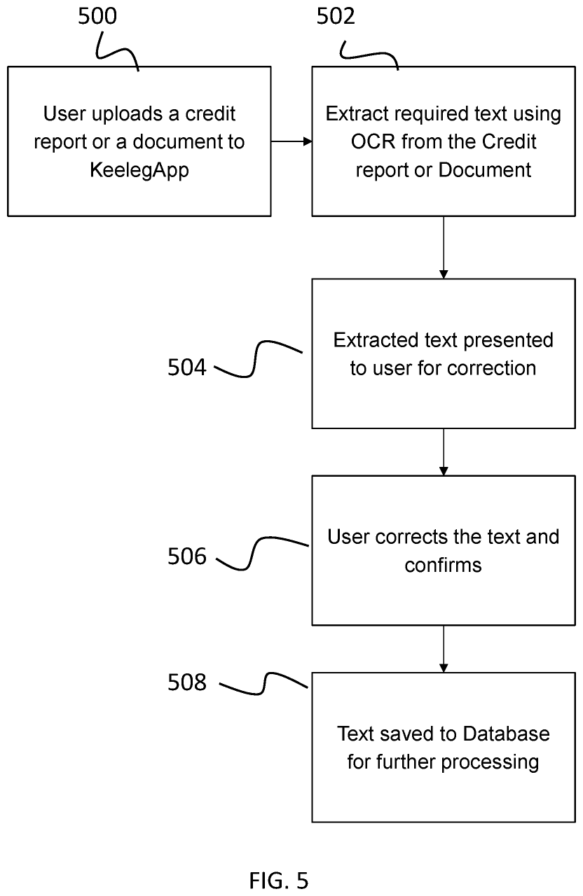

The OCR process is depicted in FIG. 5. As understood by those skilled in the art, the system allows a user to scan and upload 500 a document (e.g., credit report, social security card, driver's license, etc.) into the application. The application then extracts 502 the required text from the scanned document using a well understood OCR process. As noted above, the scanned information is then presented 504 to the user for correction. Once the user corrects 506 and confirms the information, it is saved 508 to the database for further processing.

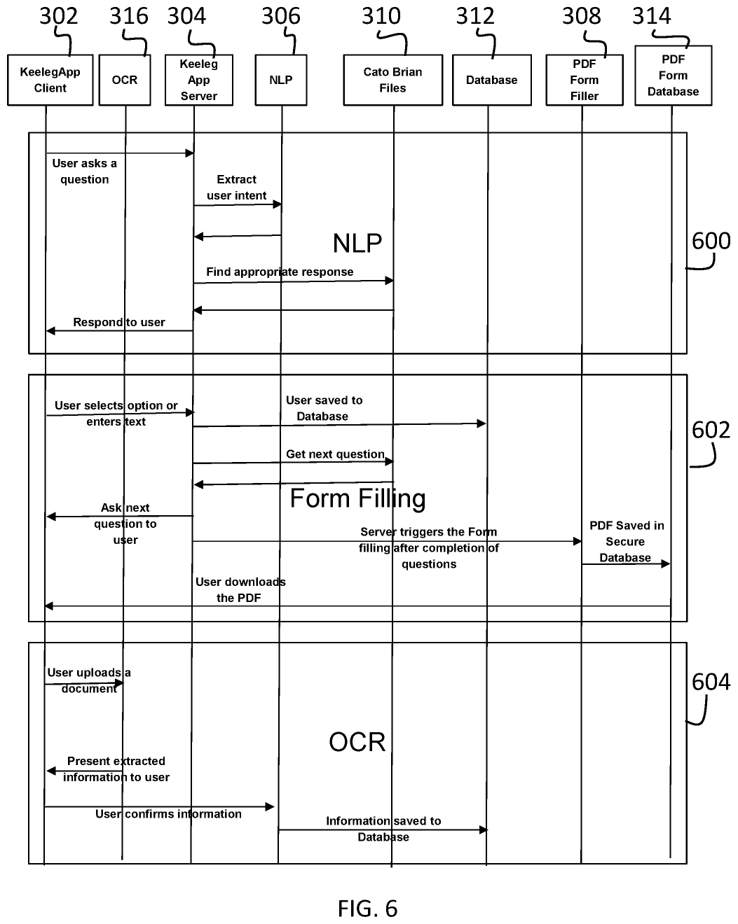

For further understanding, FIG. 6 depicts a sequence diagram, showing the architecture in relation to the various NLP 600, form filling 602, and OCR 604 processes. Specifically, FIG. 6 depicts the sequence by which the app client 302, OCR module 314, server 304, NLP 306, brain file module 310, database 312, form filler module 308, and form storage database 314 engage with one another to obtain information and create and store the final forms for download and use by the client.

In some aspects, the end user's information will be stored for future use so that the end user will not have to reinput information received by the chat bot (from prior conversations). In yet some other aspects, verbal recognition can be included that that performs similar functions as that of the chatbot (only verbal instead of through a chat bot user interface). In another aspect, the system can be devised to include a virtual reality avatar that an end user can interface with, provide information, and make selections.

Finally, while this invention has been described in terms of several embodiments, one of ordinary skill in the art will readily recognize that the invention may have other applications in other environments. It should be noted that many embodiments and implementations are possible. Further, the following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. Further, while particular method steps have been recited in a particular order, the method steps may occur in any desired order and fall within the scope of the present invention.

What is claimed is:

1. A system for automated attorney referral and legal document preparation, the system comprising:
one or more processors and associated memory, the memory being a non-transitory computer-readable medium having executable instructions encoded thereon, such that upon execution of the instructions, the one or more processors collectively perform operations of:
providing a user with a user interface, the user interface providing a list of preset options and an ask option;
receiving a selection from the user, such that:
if the user provides natural language into the ask option, processing the natural language to identify the user intent and generating a corresponding response, or
if the user selects an option from the list of preset options, then providing the user qualifying questions to determine if the user is qualified to proceed with the selected option;
if the user is qualified to proceed with the selected option, then requesting and storing information related to the selected option in a database, then generating a form related to the selected option and storing the form for download by the user; or
if the user is not qualified to proceed with the selected option, then referring the user to one or more attorneys.

2. The system as set forth in claim 1, wherein the user interface is provided to the user in a mobile application as downloaded onto the user's mobile device.

3. The system as set forth in claim 2, wherein the user interface includes a chatbot that automatically processes the user response.

4. The system as set forth in claim 3, wherein processing the natural language to identify the user intent and generating a corresponding response utilizes natural language processing.

5. The system set forth in claim 4, further comprising an operation of using optical character recognition to obtain user information for filling the form.

6. The system as set forth in claim 1, wherein the user interface includes a chatbot that automatically processes the user response.

7. The system as set forth in claim 1, wherein processing the natural language to identify the user intent and generating a corresponding response utilizes natural language processing.

8. A computer program product for automated attorney referral and legal document preparation, the computer program product comprising:
a non-transitory computer-readable medium having executable instructions encoded thereon, such that upon execution of the instructions by one or more processors, the one or more processors collectively perform operations of:
providing a user with a user interface, the user interface providing a list of preset options and an ask option;
receiving a selection from the user, such that:
if the user provides natural language into the ask option, processing the natural language to identify the user intent and generating a corresponding response, or
if the user selects an option from the list of preset options, then providing the user qualifying questions to determine if the user is qualified to proceed with the selected option;
if the user is qualified to proceed with the selected option, then requesting and storing information related to the selected option in a database, then generating a form related to the selected option and storing the form for download by the user; or
if the user is not qualified to proceed with the selected option, then referring the user to one or more attorneys.

9. The computer program product as set forth in claim 8, wherein the user interface is provided to the user in a mobile application as downloaded onto the user's mobile device.

10. The computer program product as set forth in claim 9, wherein the user interface includes a chatbot that automatically processes the user response.

11. The computer program product as set forth in claim 10, wherein processing the natural language to identify the user intent and generating a corresponding response utilizes natural language processing.

12. The computer program product set forth in claim 11, further comprising an operation of using optical character recognition to obtain user information for filling the form.

13. The computer program product as set forth in claim 8, wherein the user interface includes a chatbot that automatically processes the user response.

14. The computer program product as set forth in claim 8, wherein processing the natural language to identify the user intent and generating a corresponding response utilizes natural language processing.

15. A computer implemented method for automated attorney referral and legal document preparation, the method comprising an act of:
causing one or more processers to execute instructions encoded on a non-transitory computer-readable medium, such that upon execution, the one or more processors collectively perform operations of:
providing a user with a user interface, the user interface providing a list of preset options and an ask option;
receiving a selection from the user, such that:
if the user provides natural language into the ask option, processing the natural language to identify the user intent and generating a corresponding response, or
if the user selects an option from the list of preset options, then providing the user qualifying questions to determine if the user is qualified to proceed with the selected option;
if the user is qualified to proceed with the selected option, then requesting and storing information related to the selected option in a database, then generating a form related to the selected option and storing the form for download by the user; or
if the user is not qualified to proceed with the selected option, then referring the user to one or more attorneys.

16. The method as set forth in claim 15, wherein the user interface is provided to the user in a mobile application as downloaded onto the user's mobile device.

17. The method as set forth in claim 16, wherein the user interface includes a chatbot that automatically processes the user response.

18. The method as set forth in claim 17, wherein processing the natural language to identify the user intent and generating a corresponding response utilizes natural language processing.

19. The method set forth in claim 18, further comprising an operation of using optical character recognition to obtain user information for filling the form.

20. The method as set forth in claim 15, wherein the user interface includes a chatbot that automatically processes the user response.

21. The method as set forth in claim 15, wherein processing the natural language to identify the user intent and generating a corresponding response utilizes natural language processing.
